(19) United States
(12) Patent Application Publication
(10) Pub. No.: US 2012/0208144 A1
(43) Pub. Date: Aug. 16, 2012

(54) ORTHODONTIC ARCHWIRE WITH INTEGRAL ELEMENTS EXERTING FORCE ON THE TEETH

(75) Inventor: Paola Chiaramonte, Verona (IT)

(73) Assignee: MICHELE RECCHIA, Verona (IT)

(21) Appl. No.: 13/499,842

(22) PCT Filed: Oct. 2, 2009
(86) PCT No.: PCT/IB09/54315

§ 371 Date: Apr. 26, 2012

(51) Int. Cl. A61C 7/26

(52) U.S. Cl. 433/20

(57) ABSTRACT

An orthodontic appliance applicable to traditional appliances includes a transparent brace aligner or a traditional arch wire, generally of metal, and of plates or brackets that are fixed to the vestibular or lingual wall of the teeth. The orthodontic appliance includes a wire forming a second arc or arc portion with which one or more stressing elements are integral, with an axis substantially perpendicular to the wall of the tooth the stressing elements act on.

### TECHNICAL FIELD OF THE INVENTION

The present invention relates to an orthodontic appliance provided with an arch wire.

### BACKGROUND

Appliances are often used in orthodontics which are capable of modifying the position of a tooth or of a set of teeth, thus correcting aesthetic and/or functional defects, realigning or repositioning the dental arch correctly.

The appliances normally used consist of a metal arch wire fixed to plates (brackets) that are positioned onto the teeth.

The movement is obtained thanks to the application of relatively weak forces at predetermined time intervals.

A further type of appliance consists of a brace aligner, generally of a transparent material, to be positioned around the dental arch to obtain the realignment thereof.

The disadvantage of the above appliances consists in that the force for moving a tooth is obtained by acting as a lever on one or more nearby teeth, which in this way are moved as well, and differently moved relative to their original position.

Moreover, with the traditional or brace appliances, the movement of a tooth along the plane perpendicular to the dental arch (torque movements) is achieved in difficult way over very long periods of time.

### SUMMARY

One technical task of the present invention is to improve the prior art by eliminating the drawbacks mentioned hereinabove.

Within such technical task, it is an object of the present invention to provide an orthodontic appliance that may be anchored to the teeth or to points selected of the mouth, thus allowing to obtain the movement of the tooth or of the set of teeth to be repositioned without the need of acting as a lever on the adjacent teeth.

Moreover, since it is possible to select the anchoring points or teeth, carrying out torque movements becomes also possible, thus adopting favorable biomechanics.

Another object of the present invention is to provide an orthodontic appliance that allows the soft and physiological movement of a tooth to be repositioned having a low load-deflection coefficient and using low-friction forces.

Another object of the present invention is that the appliance can be applied alone or in addition to other traditionally used orthodontic appliances.

These and other objects are all achieved by the orthodontic appliance according to one or more of the annexed claims.

### BRIEF DESCRIPTION OF THE DRAWINGS

These and further advantages shall be better understood by the man skilled in the art from the following description and annexed drawings, provided as an example, wherein:

FIG. 1 is a perspective view of an arch wire provided with stressing elements for lingual application according to the invention;

FIG. 2 is a perspective view of a further version of the arch wire provided with stressing elements for lingual application according to the invention;

FIG. 3 is a top view of a plaster reproduction of a dental arch with connection means for lingual application of the arch wire provided with stressing elements according to the invention;

FIG. 4 is a top view of a plaster dental arch according to FIG. 3 wherein the arch wire provided with stressing elements according to FIG. 1 and/or 2 has been applied;

FIG. 5 is a top image in original corresponding to FIG. 4;

FIG. 6 is a perspective view of an arch wire provided with stressing elements for vestibular application according to the invention;

FIG. 7 is a front image of dental arch wherein the arch wire provided with stressing elements of FIG. 6 is about to be applied;

FIG. 8 shows a different method of fixing the stressing elements the arch wire of FIG. 6 or 7 is provided with;

FIG. 9 shows a subsequent step of the applying of the arch wire provided with stressing elements according to FIG. 7;

FIG. 10 is a front image of a dental arch according to the invention as applied in the vestibular version;

FIG. 11 is a front image of a dental arch according to the invention as applied in the vestibular version of an arch wire section;

FIG. 12 shows a series of connection means usable according to the invention as applied in the lingual version;

FIG. 13 shows a further version of the connection means of FIG. 12;

FIG. 14 is an enlargement of some of the connection means of FIG. 12;

FIGS. 15A, 15B and 15C are respectively a front, side and top view of a type of handmade connection means usable according to the invention applied in the lingual version;

FIGS. 16A, 16B and 16C are respectively a front, side and top view of a further type of handmade connection means provided with fixing linking,

FIG. 17 is a schematic representation of a dental arch depicting the main axes of a tooth.

### DETAILED DESCRIPTION OF PREFERRED EMBODIMENTS

With reference to the figures, reference numeral 1 globally indicates an orthodontic appliance according to the invention. Appliance 1 may be applied on a traditional fixed appliance consisting of an arch wire of metal material, which is inserted into plates (brackets) 3, consisting of metal or ceramic materials, according to the known methods.

Appliance 1 may also be applied on an appliance consisting of a brace aligner, generally of transparent material.

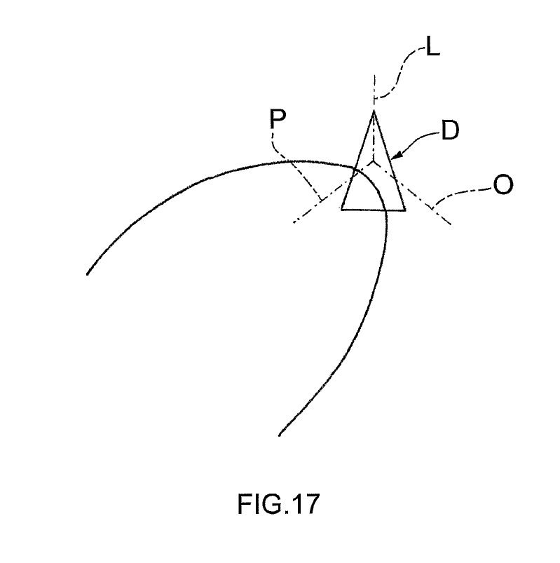

FIG. 17 schematically shows a dental arch and a tooth D belonging to such dental arch. L indicates the longitudinal axis of tooth D and O the horizontal axis thereof, tangential to the dental arch itself. P indicates the axis perpendicular to the dental arch and to axes L and O.

The concurrent use of appliance 1 with traditionally used appliances allows obtaining the movement of one or more teeth in a concurrent manner in different directions. In fact, while the traditional wire 2 and/or the brace aligner allow tooth alignment movements along the direction of the dental arch and tooth rotation movements around the longitudinal axis L thereof, appliance 1 allows obtaining torque or third degree movements, tooth alignment movements along the dental arch direction, movements along axis P and also of tooth rotation about its horizontal axis O, not all obtainable by the traditionally used appliances.

In this way, the largest movements are often obtained by the proposed appliance 1 while small movements and/or aesthetic modifications are obtained by the appliances provided with traditional mechanics and/or brace aligners.

Appliance 1 may also be applied without the aid of a traditional or brace appliance and thus be applied alone, as in FIG. 8.

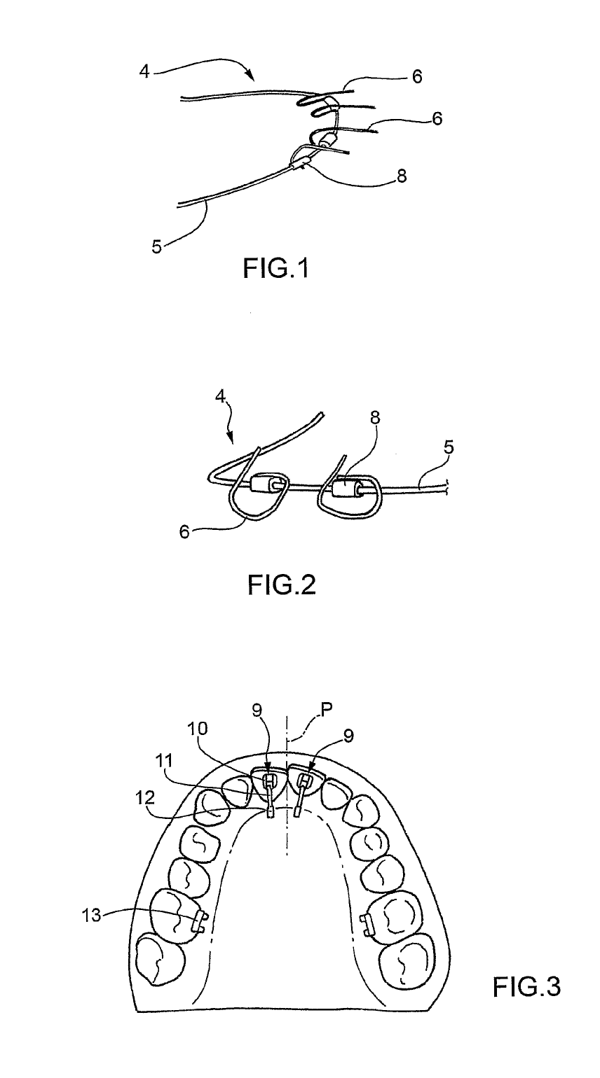

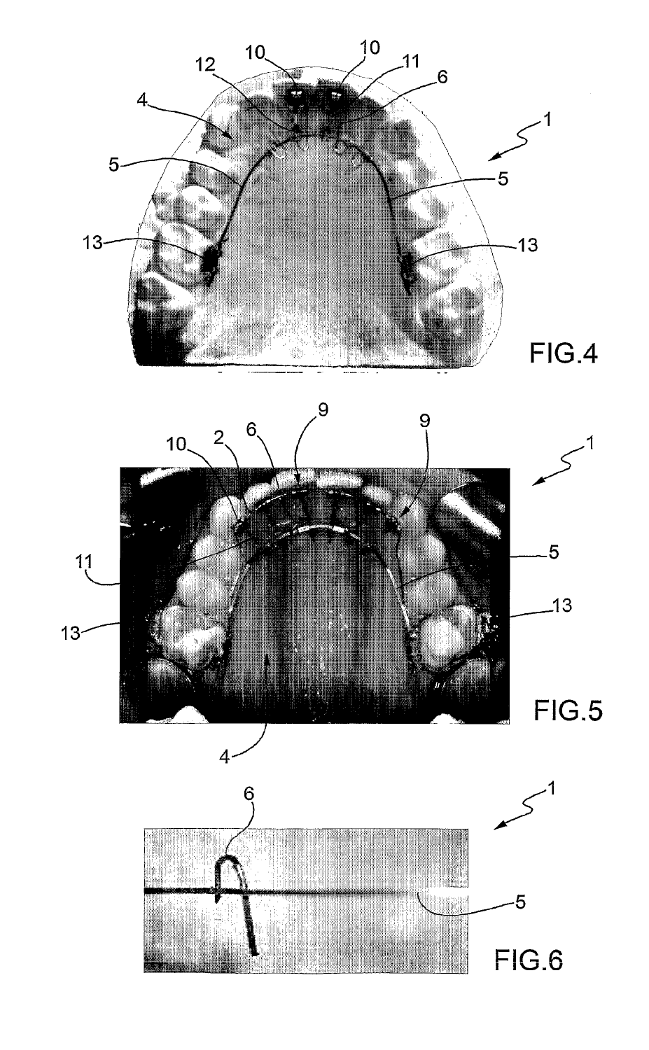

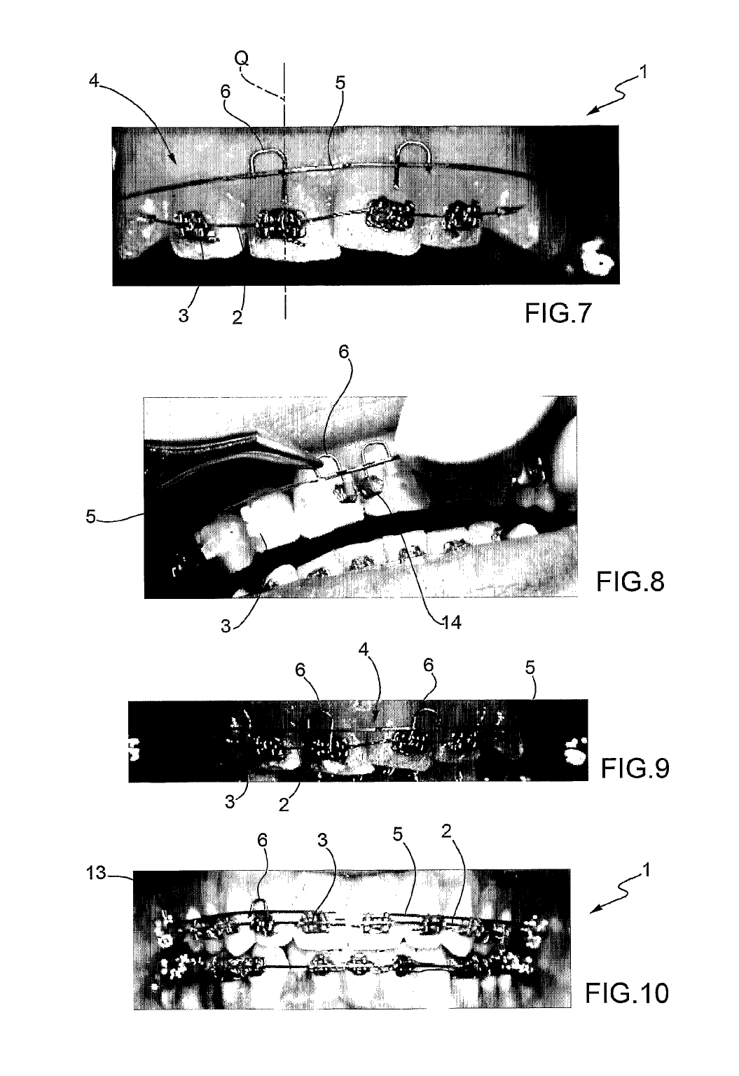

Appliance 1 may be applied both to the inside portion of the dental arch (lingual version, FIGS. 1-5) and to the outside portion of the dental arch (vestibular version, FIGS. 6-11).

Appliance 1 comprises a wire 5 that determines a driving force for the movement of the tooth/teeth to be repositioned directed along axis P substantially perpendicular to the wall of the tooth itself and/or along the direction of the dental arch and/or along the horizontal axis O of the tooth itself.

As shown in FIGS. 5, 10 and 11, when appliance 1 is combined with a traditional or brace appliance, wire 5 constitutes a second arc or arc portion 4, relative to the first arc formed by wire 2 of the traditional appliance.

Wire 5 may be of metal, mainly steel or other material such as beta titanium, beta titanium and nickel-titanium alloys; wire 5 may have a variable thickness and a square, round, rectangular section or other shape; wire 5 may be solid or hollow.

Appliance 1 further comprises one or more stressing elements (spurs) 6 integral to the wire 5 of the second arc or arc portion 4. Such stressing elements 6, when positioned on the tooth, extend at least partly along an axis Q substantially perpendicular to the plane where wire 5 lies to which they are fixed.

Usually, appliance 1 uses hooking points distant from each other, a wire 5 and one or more stressing elements 6 with smaller section than the section of wire 5. In this way, a low load-deflection coefficient is obtained for obtaining low friction forces that determine a physiological movement of the tooth to be repositioned.

In the vestibular application of appliance 1, as it is seen in the sequence of FIGS. 6-11, the stressing elements 6 are inserted into holes 7 already set up on the plates (brackets) 3, usually used for traditional appliances or of any other known type.

The stressing elements 6 may be fixed to the dental arch also through small tubes 14 or by resin, thus allowing the concurrent use of brace aligners generally of a transparent material.

The stressing elements 6 comprise a segment having a bent hooked or linear shape and can exhibit various shapes and types of shaping, according to the force to be applied to the tooth to be repositioned, to the desired flexibility of wire 5 of the second arc or arc portion 4 and to the possibility of adapting the same to the position of the tooth they are applied to. The stressing elements 6 are integral to wire 5 and may be fixed thereto by welding, melting or insertion into wire 5 in seats obtained into small hollow cylinders 8 provided on wire 5 and positioned in the areas of interest. In this way, the insertion and fixing of the stressing elements 6 are facilitated.

Such stressing elements 6 may be in single piece with said wire 5.

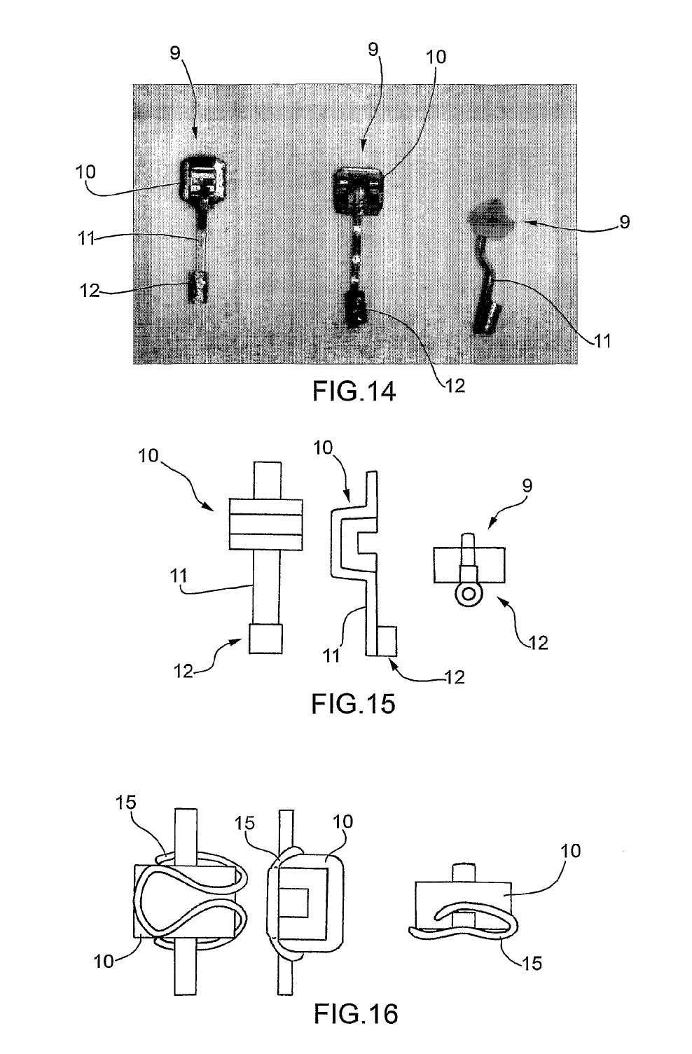

In the lingual version, appliance 1 further comprises connection means 9, which may be either traditional or a new model, which are fixed to the selected teeth. Such connection means 9 consists of a join 10, differently formed and illustrated as an example in FIGS. 12-16, to be fixed to the inside wall of the tooth and through which the traditional arch wire 2 optionally passes. Such connection means 9 may be the those marketed under the name joint Leone, joint Forestadent by the companies of the same name (FIGS. 12-14) or they may be handcrafted (FIGS. 15 and 16).

Such joins 10 may consist of resin and/or small tubes for the fixing to the tooth to be repositioned. Such connection means 9 further consist of an end 11 which extends from join 10 and ends at 12.

End 12 has any shape suitable for receiving the stressing element 6. End 12 has, for example, a hollow cylinder shape and the stressing element 6 is optionally inserted therein.

The connection means 9 may also consist of small tubes or resin and may also have other shapes and/or ways of connection to the stressing means 6, without departing from the scope of protection of the present invention.

The connection means 9 may also be linked in another manner, exhibiting at least one fixing linking 15 which may have various shapes and types, among which that with self-linking clips, to be inserted and/or locked into joins 10 of the connection means 9 for fixing wire 2 of the traditional appliance. Such fixing linking 15 may be of metal, elastic or other materials. The presence of the fixing linking 15 allows obtaining a facilitated linking.

The presence of the connection means 9, due to the fact that, on the lingual side, the space available for working is smaller than the vestibular side, allows an easier assembly of appliance 1 and improves the biomechanical aspect of the appliance itself. Thanks to the presence of the connection means 9, in fact, the wire that determines the traction may have a greater length, determining a lower load-deflection coefficient.

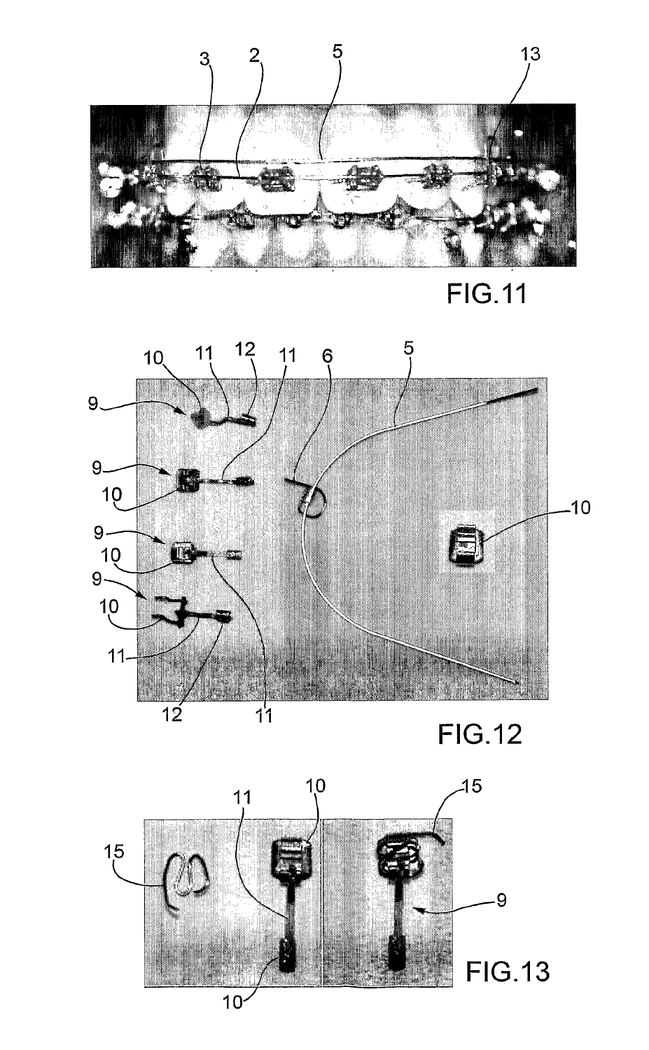

As shown in FIG. 3-5, the second arc or arc portion 4 exhibits an anchoring system 13 positioned on the molar teeth wherein wire 5 is locked on a plate positioned in the molar tooth itself. The anchoring system 13, however, can be applied to any selected tooth, as illustrated in FIG. 11, and/or to any point of the mouth, for example skeletal anchoring wherein wire 5 is anchored to the palate through the use of mini-screws or other anchoring devices.

The fact that the second arc or arc portion 4 exhibits an anchoring point 13, positioned on the molar teeth or optionally any other point of the mouth, overcomes the problem of traditional appliances wherein, to reposition a tooth, a lever action is exerted on the adjacent teeth, causing a consequent relative movement thereof. In this way, instead, the movement of the tooth to be repositioned takes place almost without anchoring loss.

The present invention has been described according to preferred embodiments but equivalent variants may be conceived without departing from the scope of protection offered by the following claims.

1. Orthodontic appliance comprising at least one wire forming an arc or arc portion and to which one or more stressing elements are integral, suitable to exerting a force on a tooth to be repositioned.

2. Orthodontic appliance according to claim 1, wherein said wire and said one or more stressing elements are configured for determining the movement of the tooth on which they act along an axis substantially perpendicular to the occlusal plane of the mouth.

3. Orthodontic appliance according to claim 1, wherein said wire and said one or more stressing elements are configured for determining the alignment of the tooth on which they act along the direction of the dental arch.

4. Orthodontic appliance according to claim 1, wherein said wire and said one or more stressing elements are configured for determining the rotation of the tooth on which they act around a horizontal axis O substantially tangential to the dental arch.

5. Orthodontic appliance according to claim 1, wherein said wire is fixed to an anchoring point in the mouth through an anchoring system.

6. Orthodontic appliance according to claim 5, wherein said anchoring system consists of said wire fixed to any tooth and/or skeletal fixing devices fixed to any point of the mouth.

7. Orthodontic appliance according to claim 1, wherein said wire consists of metal material selected from steel, alloys of beta titanium, nickel-titanium and other similar materials.

8. Orthodontic appliance according to claim 1, wherein said one or more stressing elements are fixed to said wire through welding or melting and/or insertion into seats obtained in hollow cylinders provided on said wire.

9. Orthodontic appliance according to claim 1, wherein said one or more stressing elements are in single piece with said wire.

10. Orthodontic appliance according to claim 1, wherein said one or more stressing elements, when positioned on a tooth, extend at least partly along an axis Q substantially perpendicular to the plane where the wire lies.

11. Orthodontic appliance according to claim 1, wherein said one or more stressing elements comprise a segment bents into a hook or line, whose free end is suitable for stressing the tooth to be repositioned.

12. Orthodontic appliance according to claim 1, wherein said one or more stressing elements are fixed to at least one tooth to be positioned through connection means, plates, resin and/or tubes.

13. Orthodontic appliance according to claim 12, wherein said connection means includes, in a lingual version:
a join, to be fixed to the tooth to be repositioned,
an elongated body that extends from said join and that ends with an end wherein said stressing element is inserted.

14. Orthodontic appliance according to claim 12, wherein said connection means comprises at least a fixing linking to be inserted and/or locked in at least one join of said connection means.

15. Orthodontic appliance according to claim 14, wherein said at least one fixing linking is suitable for fixing a traditional appliance.

16. Orthodontic appliance according to claim 1, wherein said wire has a larger section than the section of said stressing element.

17. Orthodontic appliance according to claim 1, wherein the orthodontic appliance is combined with a traditional orthodontic appliance.

18. Orthodontic appliance according to claim 5, wherein the anchoring system attached to the palate.
